(19) United States
(12) Patent Application Publication
(10) Pub. No.: US 2015/0249543 A1
(43) Pub. Date: Sep. 3, 2015

(54) SYSTEMS AND METHODS FOR CONNECTING A PLURALITY OF USERS BASED ON A COMMON INTEREST IN AN UNPOPULAR MEDIA ASSET

(71) Applicant: United Video Properties, Inc., Santa Clara, CA (US)

(72) Inventor: Young A. Tang, Burbank, CA (US)

(21) Appl. No.: 14/193,901

(22) Filed: Feb. 28, 2014

(51) Int. Cl. H04L 12/18

(52) U.S. Cl. CPC H04L 12/1813

(57) ABSTRACT

Systems and methods for connecting a plurality of users based on a common interest in an unpopular media asset are provided. A request from a first user to access a media asset is received. A determination is made that the media asset is unpopular by determining that popularity of the media asset is below a threshold. In response to determining that the media asset is unpopular, information, associated with the media asset, is retrieved that identifies a plurality of other users that have requested access to the media asset. A second user is selected from the plurality of other users. An indication is generated for the first user that indicates the second user has a common interest in the media asset that is unpopular.

### BACKGROUND

Traditional systems inform users about content that is popular or trending at a particular point in time. In addition, these systems may inform a user about other users who are watching particular content. These systems, however, fail to consider that there is a fraction of the population that enjoys consuming media that is not popular among a majority of people. Therefore, such indications of what is popular or trending tend to have little or no impact for these users.

### SUMMARY

In view of the foregoing, systems and methods for connecting a plurality of users based on a common interest in an unpopular media asset are provided. Specifically, the systems and methods search for other users who have viewed an unpopular media asset that a first user has viewed and identify those other users to the first user.

In some embodiments, a request from a first user to access a media asset is received. A determination is made as to whether the media asset is unpopular by determining that popularity of the media asset is below a threshold. In some implementations, popularity of the media asset is determined based on at least one of posts to an online database, status updates of users on a remote server, or microblog entries, industry ratings metrics, and user-to-user recommendations.

In response to determining that the media asset is unpopular, information, associated with the media asset, is retrieved that identifies a plurality of other users that have requested access to the media asset. In some implementations, the information is retrieved from a viewing history associated with the media asset. The other users may be identified as having requested access to the media asset in response to determining whether the other users have viewed the media asset (e.g., viewed a substantial portion of the media asset).

In some embodiments, a second user is selected from the plurality of other users that have been identified. An indication is generated for the first user that indicates the second user has a common interest in the media asset that is unpopular. In some implementations, an identifier of the second user is provided to the first user with an indication that the second user has requested access to (or has viewed) the same unpopular media asset as the first user.

In some embodiments, the second user is selected based on whether the second user is a friend of the first user. In some implementations, a list of friends associated with the first user is retrieved from a remote server. The plurality of other users is cross-referenced with the list of friends to identify which of the other users is included in the list of friends. One of the other users that is included in the list of friends is selected as the second user.

In some embodiments, the second user is selected based on whether the second user is not a friend of the first user. In some implementations, a list of friends associated with the first user is retrieved from a remote server. The plurality of other users is cross-referenced with the list of friends to identify which of the other users is not included in the list of friends. One of the other users that is not included in the list of friends is selected as the second user.

In some embodiments, whether the media asset is determined to be popular may be based on whether popularity of the media asset has changed from one point in time to another. In some implementations, a plurality of media assets that have been associated with a popularity that exceeds the threshold at a first point in time is identified. The media asset requested by the first user is determined to be unpopular by determining which of the plurality of media assets is associated with a popularity that is below the threshold at a second point in time that is later than the first point in time. In some implementations, the first point in time precedes the second point in time by more than one year.

In some embodiments, the plurality of others users who have requested access to the media asset may be identified based on which episode each of the plurality of other users have requested access to (or viewed). In some implementations, the media asset to which the first user requested access corresponds to an episode in a series. A determination is made of a first episode number associated with the media asset to which the first user requested access. A determination is made as to which of the plurality of other users has requested access to an episode of the series that is associated with a second episode number equal to or less than the first episode number. In some implementations, the determination of which of the other users has requested access may be based on whether the other users have requested access to the episode within a threshold period of time from when the first user requested access to the media asset. In some implementations, one of the other users may be selected as the second user if the one of the other users is determined to have requested access to the media asset within the threshold period of time from when the first user requested access to the media asset.

In some embodiments, the first user may request to communicate (e.g., send a message or friend request) to the second user who has also requested access to (or viewed) the same unpopular media asset. In some implementations, a communication is transmitted from the first user to the second user based on the indication that the second user has requested access to the unpopular media asset. In some implementations, the second user is added to a list of friends associated with the first user stored on a remote server.

In some embodiments, the second user is indicated to the first user based on whether the first user has completed viewing the media asset. In some implementations, the indication is generated responsive to determining that the first user has accessed the media asset from start of the media asset to end of the media asset.

### BRIEF DESCRIPTION OF THE DRAWINGS

The above and other objects and advantages of the invention will be apparent upon consideration of the following detailed description, taken in conjunction with the accompanying drawings, in which like reference characters refer to like parts throughout, and in which:

FIGS. 1 and 2 show illustrative display screens that may be used to provide media guidance application listings in accordance with an embodiment of the invention;

FIG. 3 shows an illustrative user equipment device in accordance with another embodiment of the invention;

FIG. 4 is a diagram of an illustrative cross-platform interactive media system in accordance with another embodiment of the invention;

FIG. 5 shows an illustrative display of a screen for connecting users with a common interest in an unpopular media asset in accordance with an embodiment of the invention; and

FIG. 6 shows an illustrative flow diagram of a process for connecting users with a common interest in an unpopular media asset in accordance with an embodiment of the invention.

### DETAILED DESCRIPTION

In some embodiments, a first user who accesses unpopular content receives an indication (e.g., a recommendation) identifying another user who also accessed the unpopular content. Specifically, the first user may be informed about other users who share the common interest with the first user in unpopular content. The first user may choose to connect (e.g., communicate) with the other users to discuss the unpopular content. A media guidance application may facilitate connecting these users who access unpopular content by tracking when each user accesses the unpopular content. The media guidance application may determine when a given user completes viewing/accessing the content and in response inform the user about other users who viewed/accessed the same unpopular content.

The amount of content available to users in any given content delivery system can be substantial. Consequently, many users desire a form of media guidance through an interface that allows users to efficiently navigate content selections and easily identify content that they may desire. An application that provides such guidance is referred to herein as an interactive media guidance application or, sometimes, a media guidance application or a guidance application.

Interactive media guidance applications may take various forms depending on the content for which they provide guidance. One typical type of media guidance application is an interactive television program guide. Interactive television program guides (sometimes referred to as electronic program guides) are well-known guidance applications that, among other things, allow users to navigate among and locate many types of content or media assets. Interactive media guidance applications may generate graphical user interface screens that enable a user to navigate among, locate and select content.

As referred to herein, the terms “media asset” and “content” should be understood to mean an electronically consumable user asset, such as television programming, as well as pay-per-view programs, on-demand programs (as in video-on-demand (VOD) systems), Internet content (e.g., streaming content, downloadable content, webcasts, etc.), a collection of episodes in a series, a single episode in a series, video clips, audio, content information, pictures, rotating images, documents, playlists, websites, articles, books, electronic books, blogs, advertisements, chat sessions, social media, chat rooms, applications, games, and/or any other media or multimedia and/or combination of the same. Guidance applications also allow users to navigate among and locate content. As referred to herein, the term “multimedia” should be understood to mean content that utilizes at least two different content forms described above, for example, text, audio, images, video, or interactivity content forms. Content may be recorded, played, displayed or accessed by user equipment devices, but can also be part of a live performance.

The media guidance application and/or any instructions for performing any of the embodiments discussed herein may be encoded on computer readable media. Computer readable media includes any media capable of storing data. The computer readable media may be transitory, including, but not limited to, propagating electrical or electromagnetic signals, or may be non-transitory including, but not limited to, volatile and non-volatile computer memory or storage devices such as a hard disk, floppy disk, USB drive, DVD, CD, media cards, register memory, processor caches, Random Access Memory (“RAM”), etc.

With the advent of the Internet, mobile computing, and high-speed wireless networks, users are accessing media on user equipment devices on which they traditionally did not. As referred to herein, the phrase “user equipment device,” “user equipment,” “user device,” “electronic device,” “electronic equipment,” “media equipment device,” or “media device” should be understood to mean any device for accessing the content described above, such as a television, a Smart TV, a set-top box, an integrated receiver decoder (IRD) for handling satellite television, a digital storage device, a digital media receiver (DMR), a digital media adapter (DMA), a streaming media device, a DVD player, a DVD recorder, a connected DVD, a local media server, a BLU-RAY player, a BLU-RAY recorder, a personal computer (PC), a laptop computer, a tablet computer, a WebTV box, a personal computer television (PC/TV), a PC media server, a PC media center, a hand-held computer, a stationary telephone, a personal digital assistant (PDA), a mobile telephone, a portable video player, a portable music player, a portable gaming machine, a smart phone, or any other television equipment, computing equipment, or wireless device, and/or combination of the same. In some embodiments, the user equipment device may have a front facing screen and a rear facing screen, multiple front screens, or multiple angled screens. In some embodiments, the user equipment device may have a front facing camera and/or a rear facing camera. On these user equipment devices, users may be able to navigate among and locate the same content available through a television. Consequently, media guidance may be available on these devices, as well. The guidance provided may be for content available only through a television, for content available only through one or more of other types of user equipment devices, or for content available both through a television and one or more of the other types of user equipment devices. The media guidance applications may be provided as on-line applications (i.e., provided on a web-site), or as stand-alone applications or clients on user equipment devices. Various devices and platforms that may implement media guidance applications are described in more detail below.

One of the functions of the media guidance application is to provide media guidance data to users. As referred to herein, the phrase, “media guidance data” or “guidance data” should be understood to mean any data related to content, such as media listings, media-related information (e.g., broadcast times, broadcast channels, titles, descriptions, ratings information (e.g., parental control ratings, critic's ratings, etc.), messages from a crowd of users on a social network, messages from a crowd of users posted to a blog or website, genre or category information, actor information, logo data for broadcasters' or providers' logos, etc.), media format (e.g., standard definition, high definition, 3D, etc.), advertisement information (e.g., text, images, media clips, etc.), popularity information, on-demand information, blogs, websites, and any other type of guidance data that is helpful for a user to navigate among and locate desired content selections. In some implementations, this data may be referred to as a data feed. As referred to herein the term “crowd” should be understood to mean any number of users greater than one.

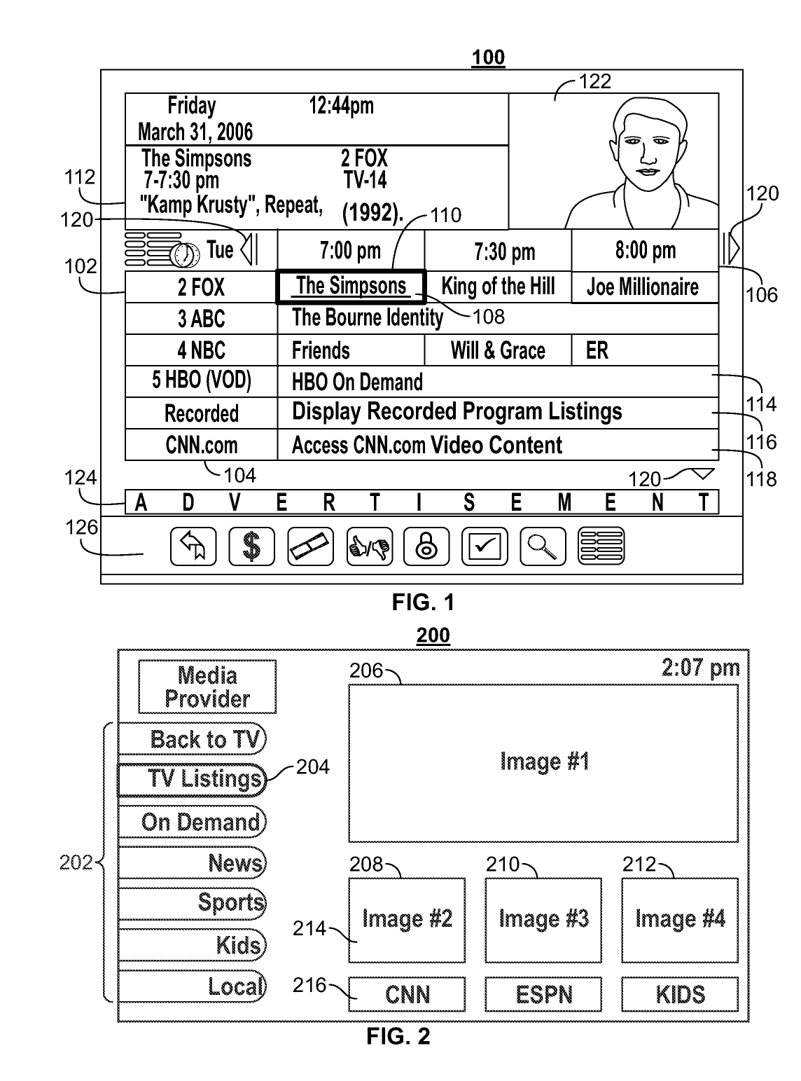

FIGS. 1-2 show illustrative display screens that may be used to provide media guidance data. The display screens shown in FIGS. 1-2 and 5 may be implemented on any suitable user equipment device or platform. While the displays of FIGS. 1-2 and 5 are illustrated as full screen displays, they may also be fully or partially overlaid over content being displayed. A user may indicate a desire to access content information by selecting a selectable option provided in a display screen (e.g., a menu option, a listings option, an icon, a hyperlink, etc.) or pressing a dedicated button (e.g., a GUIDE button) on a remote control or other user input interface or device. In response to the user's indication, the media guidance application may provide a display screen with media guidance data organized in one of several ways, such as by time and channel in a grid, by time, by channel, by source, by content type, by category (e.g., movies, sports, news, children, or other categories of programming), or other predefined, user-defined, or other organization criteria. The organization of the media guidance data is determined by guidance application data. As referred to herein, the phrase, “guidance application data” should be understood to mean data used in operating the guidance application, such as program information, guidance application settings, user preferences, or user profile information.

As referred to herein, the phrase “in response” should be understood to mean automatically, directly and immediately as a result of, without further input from the user, or automatically based on the corresponding action where intervening inputs or actions may occur.

FIG. 1 shows illustrative grid program listings display 100 arranged by time and channel that also enables access to different types of content in a single display. Display 100 may include grid 102 with: (1) a column of channel/content type identifiers 104, where each channel/content type identifier (which is a cell in the column) identifies a different channel or content type available; and (2) a row of time identifiers 106, where each time identifier (which is a cell in the row) identifies a time block of programming. Grid 102 also includes cells of program listings, such as program listing 108, where each listing provides the title of the program provided on the listing's associated channel and time. With a user input device, a user can select program listings by moving highlight region 110. Information relating to the program listing selected by highlight region 110 may be provided in program information region 112. Region 112 may include, for example, the program title, the program description, the time the program is provided (if applicable), the channel the program is on (if applicable), the program's rating, program's popularity, and other desired information.

Popularity of a media asset may be determined based on popularity information, which may include information on real time ratings (e.g., how many users are watching these media assets at this time), past ratings (e.g., how many users have previously watched this media asset by either receiving it from media content source 416 or by watching it from another source, such as in a movie theatre), ratings (e.g., a combination of both or either one of real time ratings and past ratings), critic scores, user scores, and/or user reactions. Popularity information may be received by media guidance data source 418 and/or user equipment device 300 from the third party server (e.g., a ratings website or other source of information associated with media assets) and/or media guidance data source 418 may collect the popularity information by collecting user interaction information from some or all user equipment devices in system 400 (e.g., the media guidance data source 418 may generate past ratings by collecting user interaction information on how often a particular media asset has been watched by users of system 400 and/or transmitted to user equipment devices in system 400). For example, media guidance data source 418 may receive past ratings from a third party server (e.g., the media guidance application may download box office results of a media asset from a website), receive user scores from user equipment devices, and use both sets of information to select the media assets.

In addition to, or alternative to, providing access to linear programming (e.g., content that is scheduled to be transmitted to a plurality of user equipment devices at a predetermined time and is provided according to a schedule), from content sources (e.g., television channels or scheduled streaming sources) the media guidance application may also provide access to non-linear programming (e.g., content accessible to a user equipment device at any time and not provided according to a schedule). Non-linear programming may include content from different content sources including on-demand content (e.g., VOD), Internet content (e.g., streaming media, downloadable media, etc.), locally stored content (e.g., content stored on any user equipment device described above or other storage device), or other time-independent content. On-demand content may include movies or any other content provided by a particular content provider (e.g., HBO On Demand providing “The Sopranos” and “Curb Your Enthusiasm”). HBO ON DEMAND is a service mark owned by Time Warner Company L.P. et al. and THE SOPRANOS and CURB YOUR ENTHUSIASM are trademarks owned by the Home Box Office, Inc. Internet content may include web events, such as a chat session or Webcast, or content available on-demand as streaming content or downloadable content through an Internet website or other Internet access (e.g. FTP).

Grid 102 may provide media guidance data for non-linear programming including on-demand listing 114, recorded content listing 116, and Internet content listing 118. A display combining media guidance data for content from different types of content sources is sometimes referred to as a “mixed-media” display. Various permutations of the types of media guidance data that may be displayed that are different from display 100 may be based on user selection or guidance application definition (e.g., a display of only recorded and broadcast listings, only on-demand and broadcast listings, etc.). As illustrated, listings 114, 116, and 118 are shown as spanning the entire time block displayed in grid 102 to indicate that selection of these listings may provide access to a display dedicated to on-demand listings, recorded listings, or Internet listings, respectively. In some embodiments, listings for these content types may be included directly in grid 102. Additional media guidance data may be displayed in response to the user selecting one of the navigational icons 120. (Pressing an arrow key on a user input device may affect the display in a similar manner as selecting navigational icons 120.)

Display 100 may also include video region 122, advertisement 124, and options region 126. Video region 122 may allow the user to view and/or preview programs that are currently available, will be available, or were available to the user. The content of video region 122 may correspond to, or be independent from, one of the listings displayed in grid 102. Grid displays including a video region are sometimes referred to as picture-in-guide (PIG) displays. PIG displays and their functionalities are described in greater detail in Satterfield et al. U.S. Pat. No. 6,564,378, issued May 13, 2003 and Yuen et al. U.S. Pat. No. 6,239,794, issued May 29, 2001, which are hereby incorporated by reference herein in their entireties. PIG displays may be included in other media guidance application display screens of the embodiments described herein.

Advertisement 124 may provide an advertisement for content that, depending on a viewer's access rights (e.g., for subscription programming), is currently available for viewing, will be available for viewing in the future, or may never become available for viewing, and may correspond to or be unrelated to one or more of the content listings in grid 102. Advertisement 124 may also be for products or services related or unrelated to the content displayed in grid 102. Advertisement 124 may be selectable and provide further information about content, provide information about a product or a service, enable purchasing of content, a product, or a service, provide content relating to the advertisement, etc. Advertisement 124 may be targeted based on a user's profile/preferences, monitored user activity, the type of display provided, or on other suitable targeted advertisement bases.

While advertisement 124 is shown as rectangular or banner shaped, advertisements may be provided in any suitable size, shape, and location in a guidance application display. For example, advertisement 124 may be provided as a rectangular shape that is horizontally adjacent to grid 102. This is sometimes referred to as a panel advertisement. In addition, advertisements may be overlaid over content or a guidance application display or embedded within a display. Advertisements may also include text, images, rotating images, video clips, or other types of content described above. Advertisements may be stored in a user equipment device having a guidance application, in a database connected to the user equipment, in a remote location (including streaming media servers), or on other storage means, or a combination of these locations. Providing advertisements in a media guidance application is discussed in greater detail in, for example, Knudson et al., U.S. Patent Application Publication No. 2003/0110499, filed Jan. 17, 2003; Ward, III et al. U.S. Pat. No. 6,756,997, issued Jun. 29, 2004; and Schein et al. U.S. Pat. No. 6,388,714, issued May 14, 2002, which are hereby incorporated by reference herein in their entireties. It will be appreciated that advertisements may be included in other media guidance application display screens of the embodiments described herein.

Options region 126 may allow the user to access different types of content, media guidance application displays, and/or media guidance application features. Options region 126 may be part of display 100 (and other display screens described herein), or may be invoked by a user by selecting an on-screen option or pressing a dedicated or assignable button on a user input device. The selectable options within options region 126 may concern features related to program listings in grid 102 or may include options available from a main menu display. Features related to program listings may include searching for other airtimes or ways of receiving a program, recording a program, enabling series recording of a program, setting program and/or channel as a favorite, purchasing a program, searching for other users who like unpopular content, or other features. Options available from a main menu display may include search options, VOD options (e.g., fast-access playback operations), parental control options, Internet options, cloud-based options, device synchronization options, options to view recently watched media assets, options to access various types of media guidance data displays, options to subscribe to a premium service, options to edit a user's profile, options to access a browse overlay, or other options.

The media guidance application may be personalized based on a user's preferences. A personalized media guidance application allows a user to customize displays and features to create a personalized “experience” with the media guidance application. This personalized experience may be created by allowing a user to input these customizations and/or by the media guidance application monitoring user activity to determine various user preferences. Users may access their personalized guidance application by logging in or otherwise identifying themselves to the guidance application. Customization of the media guidance application may be made in accordance with a user profile. The customizations may include varying presentation schemes (e.g., color scheme of displays, font size of text, etc.), aspects of content listings displayed (e.g., only HDTV or only 3D programming, user-specified broadcast channels based on favorite channel selections, re-ordering the display of channels, recommended content, etc.), desired recording features (e.g., recording or series recordings for particular users, recording quality, etc.), parental control settings, customized presentation of Internet content (e.g., presentation of social media content, e-mail, electronically delivered articles, etc.) and other desired customizations.

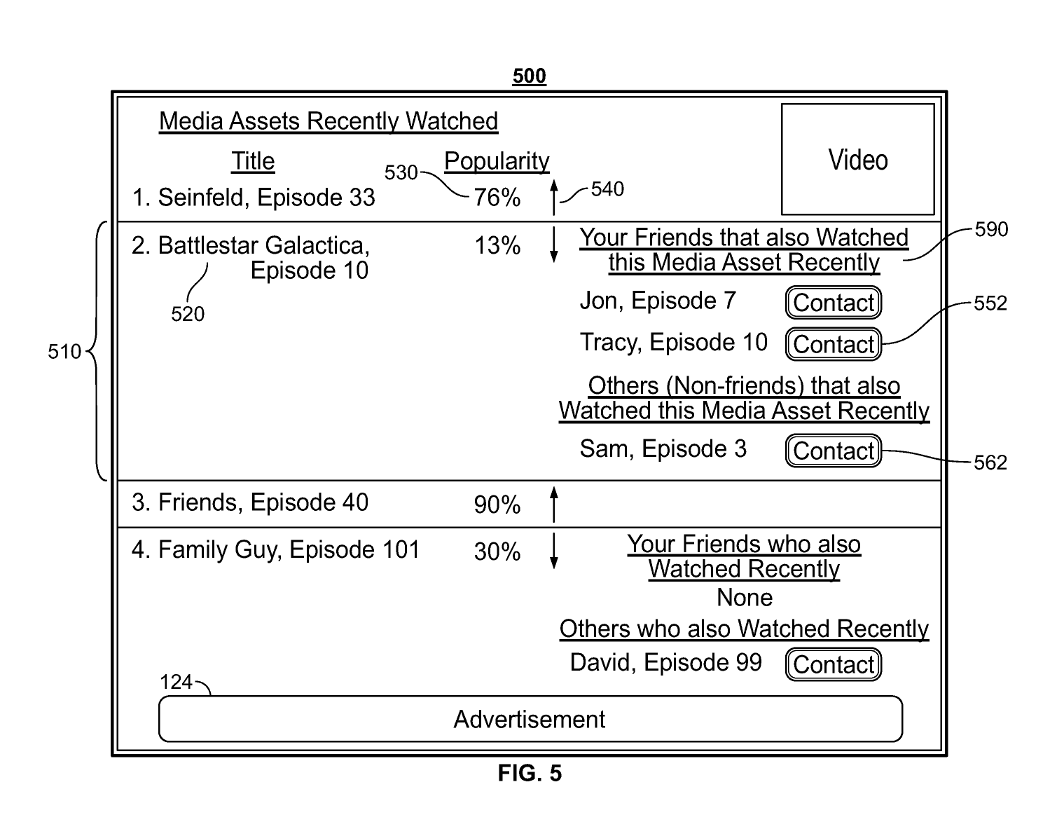

The media guidance application may allow a user to provide user profile information or may automatically compile user profile information. The media guidance application may, for example, monitor the content the user accesses and/or other interactions the user may have with the guidance application. Additionally, the media guidance application may obtain all or part of other user profiles that are related to a particular user (e.g., from other websites on the Internet the user accesses, such as www.allrovi.com, from other media guidance applications the user accesses, from other interactive applications the user accesses, from another user equipment device of the user, etc.), and/or obtain information about the user from other sources that the media guidance application may access. As a result, a user can be provided with a unified guidance application experience across the user's different user equipment devices. The user profile information may include identifiers of one or more social networks or blogs the user is associated with. For each social network or blog a username and password (e.g., log-in information) may be stored in the user profile information. Control circuitry 304 may utilize this information in the user profile to automatically access the social network or blog to post or transmit information/content/segments to or retrieve information/contents/segments from the social network or blog. This type of user experience is described in greater detail below in connection with FIG. 4. Additional personalized media guidance application features are described in greater detail in Ellis et al., U.S. Patent Application Publication No. 2005/0251827, filed Jul. 11, 2005, Boyer et al., U.S. Pat. No. 7,165,098, issued Jan. 16, 2007, and Ellis et al., U.S. Patent Application Publication No. 2002/0174430, filed Feb. 21, 2002, which are hereby incorporated by reference herein in their entireties.

As used herein, a “social network,” refers to a platform that facilitates networking and/or social relations among people who, for example, share interests, activities, backgrounds, and/or real-life connections. In some cases, social networks may facilitate communication between multiple user devices (e.g., computers, televisions, smartphones, tablets, etc.) associated with different users by exchanging content from one device to another via a social media server. As used herein, a “social media server” refers to a computer server that facilitates a social network. For example, a social media server owned/operated/used by a social media provider may make content (e.g., status updates, microblog posts, images, graphic messages, etc.) associated with a first user accessible to a second user that is within the same social network as the first user.

Another display arrangement for providing media guidance is shown in FIG. 2. Video mosaic display 200 includes selectable options 202 for content information organized based on content type, genre, and/or other organization criteria. In display 200, television listings option 204 is selected, thus providing listings 206, 208, 210, and 212 as broadcast program listings. In display 200 the listings may provide graphical images including cover art, still images from the content, video clip previews, live video from the content, or other types of content that indicate to a user the content being described by the media guidance data in the listing. Each of the graphical listings may also be accompanied by text to provide further information about the content associated with the listing. For example, listing 208 may include more than one portion, including media portion 214 and text portion 216. Media portion 214 and/or text portion 216 may be selectable to view content in full-screen or to view information related to the content displayed in media portion 214 (e.g., to view listings for the channel that the video is displayed on).

The listings in display 200 are of different sizes (i.e., listing 206 is larger than listings 208, 210, and 212), but if desired, all the listings may be the same size. Listings may be of different sizes or graphically accentuated to indicate degrees of interest to the user or to emphasize certain content, as desired by the content provider or based on user preferences. Various systems and methods for graphically accentuating content listings are discussed in, for example, Yates, U.S. Patent Application Publication No. 2010/0153885, filed Dec. 29, 2005, which is hereby incorporated by reference herein in its entirety.

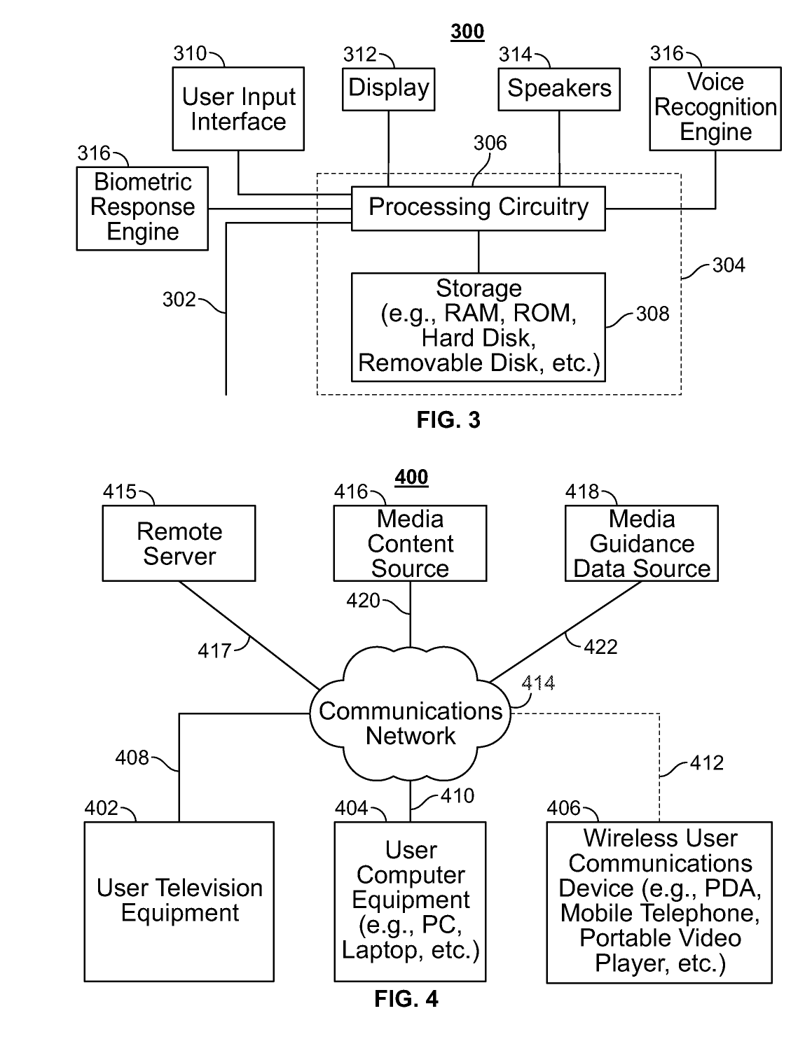

Users may access content and the media guidance application (and its display screens described above and below) from one or more of their user equipment devices. FIG. 3 shows a generalized embodiment of illustrative user equipment device 300. More specific implementations of user equipment devices are discussed below in connection with FIG. 4. User equipment device 300 may receive content and data via input/output (hereinafter “I/O”) path 302. I/O path 302 may provide content (e.g., broadcast programming, on-demand programming, Internet content, content available over a local area network (LAN) or wide area network (WAN), and/or other content) and data to control circuitry 304, which includes processing circuitry 306 and storage 308. Control circuitry 304 may be used to send and receive commands, requests, and other suitable data using I/O path 302. I/O path 302 may connect control circuitry 304 (and specifically processing circuitry 306) to one or more communications paths (described below). I/O functions may be provided by one or more of these communications paths, but are shown as a single path in FIG. 3 to avoid overcomplicating the drawing.

In some embodiments, a viewing history may be stored in storage 308 for a user. The viewing history may include indications of which media assets have been viewed by a given user. The viewing history may also include, for each media asset, which portion or portions have or have not been viewed by the user. In some implementations, the viewing history may include indications of which users in a group of users have seen or viewed a media asset or a particular segment of a media asset. The group of users may be users in a certain geographical location (e.g., in the same home), users that are associated with each other on a social network, or any set of users that have ever accessed the media asset. In some implementations, viewing history stored in storage 308 may indicate that a particular user has “viewed” the media asset only after the user has viewed a substantial portion of the media asset (e.g., more than fifty percent of the media asset or more than a threshold amount of the media asset).

In some embodiments, the viewing history may include for each user a time that represents when the user has viewed the media asset. In some implementations, control circuitry 304 may determine two users share interest in a common unpopular media asset when the two users accessed the media asset within a threshold period of time from each other (e.g., within the past week). Control circuitry 304 may determine whether the two users watched the media asset within the threshold period of time from each other based on the time stored in the viewing history that indicates when each user viewed the media asset.

In some embodiments, popularity information may be stored in storage 308. The popularity information may be specific to each media asset. In some implementations, the popularity information may be associated with multiple media assets (e.g., the same popularity may be associated with each episode in a series). In some implementations, the popularity information may be associated with each episode in a series (e.g., different popularity may be associated with each episode in a series). In some embodiments, a threshold used to determine whether a media asset is popular or unpopular may be stored in storage 308. The threshold may be automatically set or assigned by the user. In some embodiments, a list of friends of the user may be stored in storage 308. In some embodiments, a list of users who access each media asset may be stored in storage 308.

Control circuitry 304 may be based on any suitable processing circuitry such as processing circuitry 306. As referred to herein, processing circuitry should be understood to mean circuitry based on one or more microprocessors, microcontrollers, digital signal processors, programmable logic devices, field-programmable gate arrays (FPGAs), application-specific integrated circuits (ASICs), etc., and may include a multi-core processor (e.g., dual-core, quad-core, hexa-core, or any suitable number of cores) or supercomputer. In some embodiments, processing circuitry may be distributed across multiple separate processors or processing units, for example, multiple of the same type of processing units (e.g., two Intel Core i7 processors) or multiple different processors (e.g., an Intel Core i5 processor and an Intel Core i7 processor). In some embodiments, control circuitry 304 executes instructions for a media guidance application stored in memory (i.e., storage 308). Specifically, control circuitry 304 may be instructed by the media guidance application to perform the functions discussed above and below. For example, the media guidance application may provide instructions to control circuitry 304 to generate the media guidance displays. In some implementations, any action performed by control circuitry 304 may be based on instructions received from the media guidance application.

In some embodiments, control circuitry 304 may include voice or verbal input processing circuitry, such as a voice recognition engine 316. This voice or verbal input processing circuitry may include any interface that performs a voice recognition process. Control circuitry 304 may continuously or periodically access the microphone of user input interface 310 to detect the presence of voice input. Upon detecting voice input, control circuitry 304 may utilize voice recognition engine 316 (implemented in software or with dedicated circuitry) to identify who the user is who provided the verbal input. Based on this identification, control circuitry 304 may retrieve from storage 308 the corresponding authorization level of the user.

In some embodiments, control circuitry 304 may include a biometric response engine 318. Biometric response engine 318 may include circuitry that remotely or directly monitors a user's physiological and physical responses to content being presented. For example, biometric response engine 318 may include a heart pulse rate monitor, facial expression or position detection circuitry, eye movement and position detection circuitry, breathing pattern detection circuitry, user position and orientation detection circuitry, and/or any combination thereof. Control circuitry 304 may continuously or periodically access biometric response engine 318 to detect any changes in physiological and/or physical attributes (or interest) of a user at or during specified sections of a media content being presented. Upon detecting a change in the biometric response of the user (e.g., indicating change in interest), control circuitry 304 may utilize a biometric response database to identify who the user associated with the biometric response.

In client-server-based embodiments, control circuitry 304 may include communications circuitry suitable for communicating with a guidance application server or other networks or servers. The instructions for carrying out the above-mentioned functionality may be stored on the guidance application server. Communications circuitry may include a cable modem, an integrated services digital network (ISDN) modem, a digital subscriber line (DSL) modem, a telephone modem, Ethernet card, or a wireless modem for communications with other equipment, or any other suitable communications circuitry. Such communications may involve the Internet or any other suitable communications networks or paths (which are described in more detail in connection with FIG. 4). In addition, communications circuitry may include circuitry that enables peer-to-peer communication of user equipment devices, or communication of user equipment devices in locations remote from each other (described in more detail below).

Memory may be an electronic storage device provided as storage 308 that is part of control circuitry 304. As referred to herein, the phrase “electronic storage device,” “storage circuitry,” or “storage device” should be understood to mean any device for storing electronic data, computer software, or firmware, such as random-access memory, read-only memory, hard drives, optical drives, digital video disc (DVD) recorders, compact disc (CD) recorders, BLU-RAY disc (BD) recorders, BLU-RAY 3D disc recorders, digital video recorders (DVR, sometimes called a personal video recorder, or PVR), solid state devices, quantum storage devices, gaming consoles, gaming media, or any other suitable fixed or removable storage devices, and/or any combination of the same. Storage 308 may be used to store various types of content described herein as well as media guidance data and guidance application data that are described above. Nonvolatile memory may also be used (e.g., to launch a boot-up routine and other instructions). Cloud-based storage, described in relation to FIG. 4, may be used to supplement storage 308 or instead of storage 308.

Control circuitry 304 may include video generating circuitry and tuning circuitry, such as one or more analog tuners, one or more MPEG-2 decoders or other digital decoding circuitry, high-definition tuners, or any other suitable tuning or video circuits or combinations of such circuits. Encoding circuitry (e.g., for converting over-the-air, analog, or digital signals to MPEG signals for storage) may also be provided. Control circuitry 304 may also include scaler circuitry for upconverting and downconverting content into the preferred output format of the user equipment 300. Control circuitry 304 may also include digital-to-analog converter circuitry and analog-to-digital converter circuitry for converting between digital and analog signals. The tuning and encoding circuitry may be used by the user equipment device to receive and to display, to play, or to record content. The tuning and encoding circuitry may also be used to receive guidance data. The circuitry described herein, including for example, the tuning, video generating, encoding, decoding, encrypting, decrypting, scaler, and analog/digital circuitry, may be implemented using software running on one or more general purpose or specialized processors. Multiple tuners may be provided to handle simultaneous tuning functions (e.g., watch and record functions, picture-in-picture (PIP) functions, multiple-tuner recording, etc.). If storage 308 is provided as a separate device from user equipment 300, the tuning and encoding circuitry (including multiple tuners) may be associated with storage 308.

A user may send instructions to control circuitry 304 using user input interface 310. User input interface 310 may be any suitable user interface, such as a remote control, mouse, trackball, keypad, keyboard, microphone, touch screen, touchpad, stylus input, joystick, voice recognition interface, or other user input interfaces. User input interface 310 may include keys or displayed options that enable a user to instruct control circuitry 304 to access a last content source. Display 312 may be provided as a stand-alone device or integrated with other elements of user equipment device 300. Display 312 may be one or more of a monitor, a television, a liquid crystal display (LCD) for a mobile device, or any other suitable equipment for displaying visual images. For example, display 312 may be a touchscreen or touch-sensitive display. In such circumstances, user input interface 312 may be integrated with or combined with display 312. Display 312 may be one or more of a monitor, a television, a liquid crystal display (LCD) for a mobile device, amorphous silicon display, low temperature poly silicon display, electronic ink display, electrophoretic display, active matrix display, electro-wetting display, electrofluidic display, cathode ray tube display, light-emitting diode display, electroluminescent display, plasma display panel, high-performance addressing display, thin-film transistor display, organic light-emitting diode display, surface-conduction electron-emitter display (SED), laser television, carbon nanotubes, quantum dot display, interferometric modulator display, or any other suitable equipment for displaying visual images. In some embodiments, display 312 may be HDTV-capable. In some embodiments, display 312 may be a 3D display, and the interactive media guidance application and any suitable content may be displayed in 3D. A video card or graphics card may generate the output to the display 312. The video card may offer various functions such as accelerated rendering of 3D scenes and 2D graphics, MPEG-2/MPEG-4 decoding, TV output, or the ability to connect multiple monitors. The video card may be any processing circuitry described above in relation to control circuitry 304. The video card may be integrated with the control circuitry 304. Speakers 314 may be provided as integrated with other elements of user equipment device 300 or may be stand-alone units. The audio component of videos and other content displayed on display 312 may be played through speakers 314. In some embodiments, the audio may be distributed to a receiver (not shown), which processes and outputs the audio via speakers 314.

The guidance application may be implemented using any suitable architecture. For example, it may be a stand-alone application wholly implemented on user equipment device 300. In such an approach, instructions of the application are stored locally (e.g., in storage 308), and data for use by the application is downloaded on a periodic basis (e.g., from an out-of-band feed, from an Internet resource, or using another suitable approach). Control circuitry 304 may retrieve instructions of the application from storage 308 and process the instructions to generate any of the displays discussed herein. Based on the processed instructions, control circuitry 304 may determine what action to perform when input is received from input interface 310. For example, movement of a cursor on a display up/down may be indicated by the processed instructions when input interface 310 indicates that an up/down button was selected.

In some embodiments, the media guidance application is a client-server based application. Data for use by a thick or thin client implemented on user equipment device 300 is retrieved on-demand by issuing requests to a server remote to the user equipment device 300. In one example of a client-server based guidance application, control circuitry 304 runs a web browser that interprets web pages provided by a remote server. For example, the remote server may store the instructions for the application in a storage device. The remote server may process the stored instructions using circuitry (e.g., control circuitry 304) and generate the displays discussed above and below. The client device may receive the displays generated by the remote server and may display the content of the displays locally on equipment device 300. This way, the processing of the instructions is performed remotely by the server while the resulting displays are provided locally on equipment device 300. Equipment device 300 may receive inputs from the user via input interface 310 and transmit those inputs to the remote server for processing and generating the corresponding displays. For example, equipment device 300 may transmit a communication to the remote server indicating that an up/down button was selected via input interface 310. The remote server may process instructions in accordance with that input and generate a display of the application corresponding to the input (e.g., a display that moves a cursor up/down). The generated display is then transmitted to equipment device 300 for presentation to the user.

In some embodiments, the media guidance application is downloaded and interpreted or otherwise run by an interpreter or virtual machine (run by control circuitry 304). In some embodiments, the guidance application may be encoded in the ETV Binary Interchange Format (EBIF), received by control circuitry 304 as part of a suitable feed, and interpreted by a user agent running on control circuitry 304. For example, the guidance application may be an EBIF application. In some embodiments, the guidance application may be defined by a series of JAVA-based files that are received and run by a local virtual machine or other suitable middleware executed by control circuitry 304. In some of such embodiments (e.g., those employing MPEG-2 or other digital media encoding schemes), the guidance application may be, for example, encoded and transmitted in an MPEG-2 object carousel with the MPEG audio and video packets of a program.

User equipment device 300 of FIG. 3 can be implemented in system 400 of FIG. 4 as user television equipment 402, user computer equipment 404, wireless user communications device 406, or any other type of user equipment suitable for accessing content, such as a non-portable gaming machine. For simplicity, these devices may be referred to herein collectively as user equipment or user equipment devices, and may be substantially similar to user equipment devices described above. User equipment devices, on which a media guidance application may be implemented, may function as a stand-alone device or may be part of a network of devices. Various network configurations of devices may be implemented and are discussed in more detail below.

A user equipment device utilizing at least some of the system features described above in connection with FIG. 3 may not be classified solely as user television equipment 402, user computer equipment 404, or a wireless user communications device 406. For example, user television equipment 402 may, like some user computer equipment 404, be Internet-enabled allowing for access to Internet content, while user computer equipment 404 may, like some television equipment 402, include a tuner allowing for access to television programming. The media guidance application may have the same layout on various different types of user equipment or may be tailored to the display capabilities of the user equipment. For example, on user computer equipment 404, the guidance application may be provided as a website accessed by a web browser. In another example, the guidance application may be scaled down for wireless user communications devices 406.

In system 400, there is typically more than one of each type of user equipment device but only one of each is shown in FIG. 4 to avoid overcomplicating the drawing. In addition, each user may utilize more than one type of user equipment device and also more than one of each type of user equipment device.

In some embodiments, a user equipment device (e.g., user television equipment 402, user computer equipment 404, wireless user communications device 406) may be referred to as a “second screen device.” For example, a second screen device may supplement content presented on a first user equipment device. The content presented on the second screen device may be any suitable content that supplements the content presented on the first device. In some embodiments, the second screen device provides an interface for adjusting settings and display preferences of the first device. In some embodiments, the second screen device is configured for interacting with other second screen devices or for interacting with a social network. The second screen device can be located in the same room as the first device, a different room from the first device but in the same house or building, or in a different building from the first device (e.g., remote from the first device).

The user may also set various settings to maintain consistent media guidance application settings across in-home devices and remote devices. Settings include those described herein, as well as channel and program favorites, programming preferences that the guidance application utilizes to make programming recommendations, display preferences, and other desirable guidance settings. For example, if a user sets a channel as a favorite on, for example, the website www.allrovi.com on their personal computer at their office, the same channel would appear as a favorite on the user's in-home devices (e.g., user television equipment and user computer equipment) as well as the user's mobile devices, if desired. Therefore, changes made on one user equipment device can change the guidance experience on another user equipment device, regardless of whether they are the same or a different type of user equipment device. In addition, the changes made may be based on settings input by a user, as well as user activity monitored by the guidance application.

The user equipment devices may be coupled to communications network 414. Namely, user television equipment 402, user computer equipment 404, and wireless user communications device 406 are coupled to communications network 414 via communications paths 408, 410, and 412, respectively. Each user of the user equipment devices may be associated with different users in a crowd of users. Communications network 414 may be one or more networks including the Internet, a mobile phone network, mobile voice or data network (e.g., a 4G or LTE network), cable network, public switched telephone network, or other types of communications network or combinations of communications networks. Paths 408, 410, and 412 may separately or together include one or more communications paths, such as a satellite path, a fiber-optic path, a cable path, a path that supports Internet communications (e.g., IPTV), free-space connections (e.g., for broadcast or other wireless signals), or any other suitable wired or wireless communications path or combination of such paths. Path 412 is drawn with dotted lines to indicate that in the exemplary embodiment shown in FIG. 4 it is a wireless path and paths 408 and 410 are drawn as solid lines to indicate they are wired paths (although these paths may be wireless paths, if desired). Communications with the user equipment devices may be provided by one or more of these communications paths, but are shown as a single path in FIG. 4 to avoid overcomplicating the drawing.

Although communications paths are not drawn between user equipment devices, these devices may communicate directly with each other via communication paths, such as those described above in connection with paths 408, 410, and 412, as well as other short-range point-to-point communication paths, such as USB cables, IEEE 1394 cables, wireless paths (e.g., Bluetooth, infrared, IEEE 802-11x, etc.), or other short-range communication via wired or wireless paths. BLUETOOTH is a certification mark owned by Bluetooth SIG, INC. The user equipment devices may also communicate with each other directly through an indirect path via communications network 414.

System 400 includes content source 416 and media guidance data source 418 coupled to communications network 414 via communication paths 420 and 422, respectively. Paths 420 and 422 may include any of the communication paths described above in connection with paths 408, 410, and 412. Communications with the content source 416 and media guidance data source 418 may be exchanged over one or more communications paths, but are shown as a single path in FIG. 4 to avoid overcomplicating the drawing. In addition, there may be more than one of each of content source 416 and media guidance data source 418, but only one of each is shown in FIG. 4 to avoid overcomplicating the drawing. (The different types of each of these sources are discussed below.) If desired, content source 416 and media guidance data source 418 may be integrated as one source device. Although communications between sources 416 and 418 with user equipment devices 402, 404, and 406 are shown as through communications network 414, in some embodiments, sources 416 and 418 may communicate directly with user equipment devices 402, 404, and 406 via communication paths (not shown) such as those described above in connection with paths 408, 410, and 412.

Content source 416 may include one or more types of content distribution equipment including a television distribution facility, cable system headend, satellite distribution facility, programming sources (e.g., television broadcasters, such as NBC, ABC, HBO, etc.), intermediate distribution facilities and/or servers, Internet providers, on-demand media servers, and other content providers. NBC is a trademark owned by the National Broadcasting Company, Inc., ABC is a trademark owned by the American Broadcasting Company, Inc., and HBO is a trademark owned by the Home Box Office, Inc. Content source 416 may be the originator of content (e.g., a television broadcaster, a Webcast provider, etc.) or may not be the originator of content (e.g., an on-demand content provider, an Internet provider of content of broadcast programs for downloading, etc.). Content source 416 may include cable sources, satellite providers, on-demand providers, Internet providers, over-the-top content providers, or other providers of content. Content source 416 may also include a remote media server used to store different types of content (including video content selected by a user), in a location remote from any of the user equipment devices. Systems and methods for remote storage of content, and providing remotely stored content to user equipment are discussed in greater detail in connection with Ellis et al., U.S. Pat. No. 7,761,892, issued Jul. 20, 2010, which is hereby incorporated by reference herein in its entirety.

Media guidance data source 418 may provide media guidance data, such as the media guidance data described above. Media guidance application data may be provided to the user equipment devices using any suitable approach. In some embodiments, the guidance application may be a stand-alone interactive television program guide that receives program guide data via a data feed (e.g., a continuous feed or trickle feed).

Program schedule data and other guidance data may be provided to the user equipment on a television channel sideband, using an in-band digital signal, using an out-of-band digital signal, or any other suitable data transmission technique. Program schedule data and other media guidance data may be provided to user equipment on multiple analog or digital television channels.

In some embodiments, guidance data from media guidance data source 418 may be provided to users' equipment using a client-server approach. For example, a user equipment device may pull media guidance data from a server, or a server may push media guidance data to a user equipment device. In some embodiments, a guidance application client residing on the user's equipment may initiate sessions with source 418 to obtain guidance data when needed, e.g., when the guidance data is out of date or when the user equipment device receives a request from the user to receive data. Media guidance may be provided to the user equipment with any suitable frequency (e.g., continuously, daily, a user-specified period of time, a system-specified period of time, in response to a request from user equipment, etc.). Media guidance data source 418 may provide user equipment devices 402, 404, and 406 the media guidance application itself or software updates for the media guidance application.

Media guidance applications may be, for example, stand-alone applications implemented on user equipment devices. For example, the media guidance application may be implemented as software or a set of executable instructions which may be stored in storage 308, and executed by control circuitry 304 of a user equipment device 300. In some embodiments, media guidance applications may be client-server applications where only a client application resides on the user equipment device, and server application resides on a remote server. For example, media guidance applications may be implemented partially as a client application on control circuitry 304 of user equipment device 300 and partially on a remote server as a server application (e.g., media guidance data source 418) running on control circuitry of remote server 415. When executed by control circuitry of remote server 415 (such as media guidance data source 418), the media guidance application may instruct the control circuitry to generate the guidance application displays and transmit the generated displays to the user equipment devices. The server application may instruct the control circuitry of the media guidance data source 418 to transmit data for storage on the user equipment. The client application may instruct control circuitry of the receiving user equipment to generate the guidance application displays.

Content and/or media guidance data delivered to user equipment devices 402, 404, and 406 may be over-the-top (OTT) content. OTT content delivery allows Internet-enabled user devices, including any user equipment device described above, to receive content that is transferred over the Internet, including any content described above, in addition to content received over cable or satellite connections. OTT content is delivered via an Internet connection provided by an Internet service provider (ISP), but a third party distributes the content. The ISP may not be responsible for the viewing abilities, copyrights, or redistribution of the content, and may only transfer IP packets provided by the OTT content provider. Examples of OTT content providers include YOUTUBE, NETFLIX, and HULU, which provide audio and video via IP packets. Youtube is a trademark owned by Google Inc., Netflix is a trademark owned by Netflix Inc., and Hulu is a trademark owned by Hulu, LLC. OTT content providers may additionally or alternatively provide media guidance data described above. In addition to content and/or media guidance data, providers of OTT content can distribute media guidance applications (e.g., web-based applications or cloud-based applications), or the content can be displayed by media guidance applications stored on the user equipment device.

Media guidance system 400 is intended to illustrate a number of approaches, or network configurations, by which user equipment devices and sources of content and guidance data may communicate with each other for the purpose of accessing content and providing media guidance. The embodiments described herein may be applied in any one or a subset of these approaches, or in a system employing other approaches for delivering content and providing media guidance. The following four approaches provide specific illustrations of the generalized example of FIG. 4.

In one approach, user equipment devices may communicate with each other within a home network. User equipment devices can communicate with each other directly via short-range point-to-point communication schemes described above, via indirect paths through a hub or other similar device provided on a home network, or via communications network 414. Each of the multiple individuals in a single home may operate different user equipment devices on the home network. As a result, it may be desirable for various media guidance information or settings to be communicated between the different user equipment devices. For example, it may be desirable for users to maintain consistent media guidance application settings on different user equipment devices within a home network, as described in greater detail in Ellis et al., U.S. patent application Ser. No. 11/179,410, filed Jul. 11, 2005. Different types of user equipment devices in a home network may also communicate with each other to transmit content. For example, a user may transmit content from user computer equipment to a portable video player or portable music player.

In a second approach, users may have multiple types of user equipment by which they access content and obtain media guidance. For example, some users may have home networks that are accessed by in-home and mobile devices. Users may control in-home devices via a media guidance application implemented on a remote device. For example, users may access an online media guidance application on a website via a personal computer at their office, or a mobile device such as a PDA or web-enabled mobile telephone. The user may set various settings (e.g., recordings, reminders, or other settings) on the online guidance application to control the user's in-home equipment. The online guide may control the user's equipment directly, or by communicating with a media guidance application on the user's in-home equipment. Various systems and methods for user equipment devices communicating, where the user equipment devices are in locations remote from each other, is discussed in, for example, Ellis et al., U.S. Pat. No. 8,046,801, issued Oct. 25, 2011, which is hereby incorporated by reference herein in its entirety.

In a third approach, users of user equipment devices inside and outside a home can use their media guidance application to communicate directly with content source 416 to access content. Specifically, within a home, users of user television equipment 402 and user computer equipment 404 may access the media guidance application to navigate among and locate desirable content. Users may also access the media guidance application outside of the home using wireless user communications devices 406 to navigate among and locate desirable content.

In a fourth approach, user equipment devices may operate in a cloud computing environment to access cloud services. In a cloud computing environment, various types of computing services for content sharing, storage or distribution (e.g., video sharing sites, blogs, news sites, or social networking sites) are provided by a collection of network-accessible computing and storage resources, referred to as “the cloud.” For example, the cloud can include a collection of server computing devices, which may be located centrally or at distributed locations, that provide cloud-based services to various types of users and devices connected via a network such as the Internet via communications network 414. These cloud resources may include one or more content sources 416 and one or more media guidance data sources 418. In addition or in the alternative, the remote computing sites may include other user equipment devices, such as user television equipment 402, user computer equipment 404, and wireless user communications device 406. For example, the other user equipment devices may provide access to a stored copy of a video or a streamed video. In such embodiments, user equipment devices may operate in a peer-to-peer manner without communicating with a central server.

The cloud provides access to services, such as content storage, content sharing, access to messages posted by users in a crowd, or social networking services, among other examples, as well as access to any content described above, for user equipment devices. Services can be provided in the cloud through cloud computing service providers, or through other providers of online services. For example, the cloud-based services can include a content storage service, a content sharing site, a social networking site, or other services via which user-sourced content is distributed for viewing by others on connected devices. These cloud-based services may allow a user equipment device to store content to the cloud and to receive content from the cloud rather than storing content locally and accessing locally stored content.

A user may use various content capture devices, such as camcorders, digital cameras with video mode, audio recorders, mobile phones, and handheld computing devices, to record content. The user can upload content to a content storage service on the cloud either directly, for example, from user computer equipment 404 or wireless user communications device 406 having content capture feature. Alternatively, the user can first transfer the content to a user equipment device, such as user computer equipment 404. The user equipment device storing the content uploads the content to the cloud using a data transmission service on communications network 414. In some embodiments, the user equipment device itself is a cloud resource, and other user equipment devices can access the content directly from the user equipment device on which the user stored the content.

Cloud resources may be accessed by a user equipment device using, for example, a web browser, a media guidance application, a desktop application, a mobile application, and/or any combination of access applications of the same. The user equipment device may be a cloud client that relies on cloud computing for application delivery, or the user equipment device may have some functionality without access to cloud resources. For example, some applications running on the user equipment device may be cloud applications, i.e., applications delivered as a service over the Internet, while other applications may be stored and run on the user equipment device. In some embodiments, a user device may receive content from multiple cloud resources simultaneously. For example, a user device can stream audio from one cloud resource while downloading content from a second cloud resource. Or a user device can download content from multiple cloud resources for more efficient downloading. In some embodiments, user equipment devices can use cloud resources for processing operations such as the processing operations performed by processing circuitry described in relation to FIG. 3.

In some embodiments, a request from a first user to access a media asset may be received by control circuitry 304. Control circuitry 304 may, in response, determine that the media asset is unpopular by determining that popularity of the media asset is below a threshold. In some implementations, control circuitry 304 may retrieve the popularity of the media asset and the threshold from storage 308. In response to determining that the media asset is unpopular, control circuitry 304 may retrieve information, associated with the media asset, from storage 308 that identifies a plurality of other users that have requested access to the media asset. Control circuitry 304 may select a second user from the plurality of other users. Control circuitry 304 may generate an indication for the first user that indicates the second user has a common interest in the media asset that is unpopular.

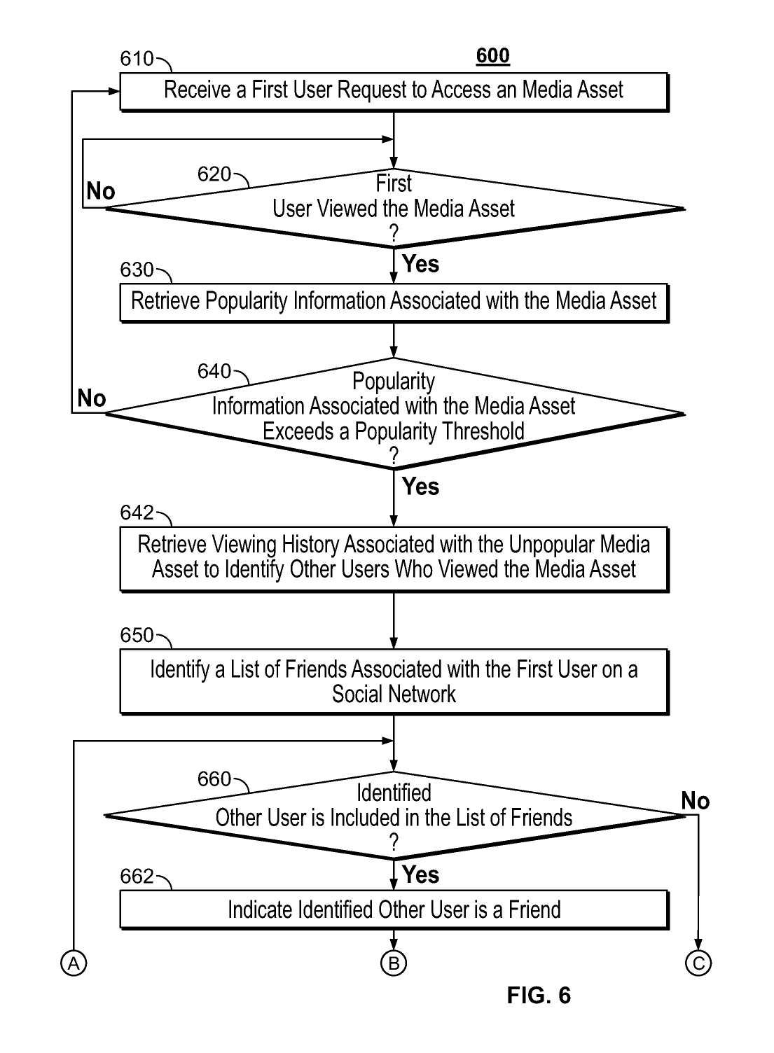

FIG. 5 shows an illustrative display of a screen 500 for connecting users with a common interest in an unpopular media asset in accordance with an embodiment of the invention. Specifically, screen 500 shows indications generated by control circuitry 304 for the first user. These indications indicate one or more other users that have a common interest, in the unpopular media asset, as the first user (e.g., the user who requested access to the media asset). In some implementations, control circuitry 304 navigates the user to screen 500 in response to receiving a user request to view a list of media assets recently watched. In some implementations, control circuitry 304 navigates the user to screen 500 automatically in response to the user having finished viewing a given media asset. In such circumstances, the information presented in screen 500 may be specific to only the media asset the user has most recently finished viewing.

Screen 500 may include a media asset information region 510. Media asset information region 510 may include an identifier 520 of the media asset that was recently viewed, popularity information 530, and indication of other users who accessed the media asset corresponding to identifier 520. A media asset may be added to the list of media assets shown in screen 500 if the media asset has been recently accessed. The media guidance application may determine whether a media asset has recently been accessed by retrieving information associated with the user that is stored in the viewing history of storage 308. Specifically, the media guidance application may retrieve the times identifying when the user viewed or completed viewing each media asset stored in the viewing history. The media guidance application may compare the retrieved times with a threshold. Any time that is less than the threshold may be associated with a media asset that was recently accessed. In particular, the media guidance application may select for inclusion in screen 500 any media asset that is associated with a viewing time or access time that is less than the threshold.

The threshold used by the media guidance application to determine whether the media asset was recently accessed may be manually adjusted or automatically set. In some embodiments, the user may select what viewing time qualifies as recently viewed and may instruct the media guidance application to store that indication in storage 308 as the threshold. In some embodiments, the viewing time that qualifies as recently viewed may be automatically set by the media guidance application and stored in storage 308 as the threshold.

In some embodiments, the media guidance application may display popularity information 530 for each media asset presented in screen 500. Specifically, the media guidance application may retrieve from storage 308 the corresponding popularity information and display the retrieved popularity information as information 530. The popularity information may represent a percentage of the population that has liked or enjoyed the corresponding media asset. A higher percentage of popularity information may correspond to a greater popularity (e.g., more people liked or enjoyed the media asset). A lower percentage of popularity information may correspond to a lower popularity (e.g., fewer people liked or enjoyed the media asset).

The media guidance application may present a popularity indicator 540 next to the popularity information. Popularity indicator 540 may visually indicate to the user whether the media asset is popular or unpopular. Specifically, the media guidance application may compare the popularity information with a popularity threshold. In response to determining that the popularity information exceeds the popularity threshold, the media guidance application may associate the corresponding media asset with an indicator that indicates the media asset to be popular. In response to determining that the popularity information does not exceed the popularity threshold, the media guidance application may associate the corresponding media asset with an indicator that indicates the media asset to be unpopular. An indicator that indicates the media asset to be popular may be, for example, presented in one form (e.g., an up arrow or smiley face). An indicator that indicates the media asset to be unpopular may be, for example, presented in a different second form (e.g., a down arrow or sad face). Any other visual presentation of whether the media asset is popular or unpopular may be provided.

In some embodiments, the popularity threshold may be selected by the user. For example, the media guidance application may receive a user selection of indicator 540. In response, the media guidance application may request input from the user increasing or decreasing the popularity threshold. This enables the user to reduce or increase the number of media assets the media guidance application determines to be unpopular for use in identifying other users who have an interest in the media asset. In some embodiments, the popularity threshold is selected automatically by the media guidance application. For example, the media guidance application may select a popularity threshold that is low enough such that only one media asset is determined to be unpopular.

In some embodiments, the media guidance application may determine whether a media asset is popular or unpopular based on historical popularity of the media asset. In particular, the media guidance application may retrieve historical popularity information that indicates a popularity of the media asset along a timeline from when the media asset was originally made available to a plurality of users to the current date and time. The media guidance application may compare each of the popularity indications along the timeline with the popularity threshold to detect whether popularity of the media asset changed. For example, the media guidance application may determine that a given media asset was popular over a year ago (e.g., was associated with a popularity level that exceeds the popularity threshold) but currently is unpopular (e.g., is associated with a popularity level that does not exceed the popularity threshold). In response, the media guidance application may visually distinguish such a media asset in screen 500 from other media assets that are not associated with a change in popularity over time. In particular, the media asset “Seinfeld” may be determined to have been popular in the past (e.g., since it was released or originally made available) and is still popular. Accordingly, the media guidance application may present the identifier 520 of “Seinfeld” in a different manner than the identifier 520 of “Battlestar Galactica” (e.g., a media asset that was popular in the past but is currently unpopular). In some implementations, the media guidance application may limit the indications of media assets in screen 500 to only those indications that are associated with media assets that were once popular (e.g., over a year ago) and currently are unpopular.

In some implementations, a media asset that the media guidance application determines to be popular may have the corresponding identifier 520 visually distinguished from a media asset determined to be unpopular. For example, identifier 520 of the media asset “Seinfeld” which may be popular may be presented in a first color (e.g., red) whereas identifier 520 of the media asset “Battlestar Galactica” which may be unpopular may be presented in a second color (e.g., green).

In some embodiments, the media guidance application may present other users who accessed the media asset only for unpopular media assets. For example, the media guidance application may present the other users in region 590 for unpopular media asset “Battlestar Galactica” shown in the second row of media assets in screen 500 but may not present other users region 590 for popular media asset “Seinfeld” shown in the first row of media assets in screen 500.

In some embodiments, the media guidance application may present identifiers of other users who accessed the media asset for all media assets shown in screen 500. As referred to herein, in the context of presenting or displaying identifications or listings identifying other users, the phrases “presenting other users,” “presenting representations of other users,” “presenting indications of other users,” and “presenting identifiers of other users” have the same meaning. For example, the media guidance application may present the other users region 590 for unpopular media asset “Battlestar Galactica” shown in the second row of media assets in screen 500 and also present other users region 590 for popular media asset “Seinfeld” shown in the first row of media assets in screen 500.

Other users region 590 may include a region presenting friends of the user who accessed the unpopular media asset (e.g., “Battlestar Galactica”). In some embodiments, the media guidance application may request from a social network server a list of users who are associated with the first user. For example, the media guidance application may transmit an identifier of the first user to the social network server. The social network server may, in response to receiving the identifier of the first user, send back to the media guidance application friends of the first user (e.g., a list of users that are associated with the first user on the social network hosted by the social network server). The media guidance application may cross-reference the received list of users associated with the first user with users in the viewing history who accessed the same unpopular media asset as the first user. The media guidance application may select only those users in the viewing history that accessed or viewed the same unpopular media asset as the first user and who are included in the list of users that are associated with the user. The media guidance application may present the selected users in the region of region 590 which presents friends of the user who accessed the unpopular media asset.

Other users region 590 may include a region presenting non-friends of the user who accessed the unpopular media asset. The media guidance application may identify all the users in the viewing history who accessed the same unpopular media asset as the first user. The media guidance application may select only those users in the viewing history that accessed or viewed the same unpopular media asset as the first user. The media guidance application may present the selected users in the region of region 590 which presents non-friends of the user who accessed the unpopular media asset.

In some embodiments, the media guidance application may visually distinguish users who are presented in region 590 based on a progression point of the users within the media asset relative to the progression point of the first user within the media asset. For example, the first user may have only viewed up to the first 30 minutes of an hour-long movie. Accordingly, the media guidance application may present identifiers of those users in region 590 that have also only viewed up to the first 30 minutes of the movie differently from identifiers of those users in region 590 that have viewed past the first 30 minutes of the movie. For example, a user who is identified in region 590 and has viewed the first 15 minutes of the movie may be represented using an identifier in a first color whereas a different user who is identified in region 590 and has viewed the first 45 minutes of the movie may be represented using a different identifier in a second color. Namely, both of the users' names may be presented in region 590 as having accessed the same unpopular media asset as the first user. But each of the names of the other users may be visually distinguished (e.g., using different colors) based on whether the respective user has viewed up to the portion that the first user has viewed up to or has surpassed the portion viewed by the first user.

In some embodiments, the progression point may correspond to a particular episode in a series. For example, the media asset “Battlestar Galactica” may be correspond to a series of episodes. The media guidance application may present identifier 520 that corresponds to a particular episode of the series that the first user has recently accessed (e.g., episode 10). The media guidance application may present in other users region 590 any user who has accessed any episode in the series. Alternatively, the media guidance application may present in region 590 only those users who have accessed the identical episode as the first user or have accessed up to the identical episode. Alternatively, or in addition, the media guidance application may present in region 590 only those users who have accessed the identical episode as the first user or have accessed up to the identical episode within a threshold period of time of when the first user accessed or viewed the episode in the series.

For example, the media guidance application may identify which episode number the other users have accessed. The media guidance application may compare the episode number of the media asset that the other users have accessed to the episode number of the media asset that the first user has accessed. In response to determining that the episode number (e.g., episode 13) accessed by the other user exceeds the episode number that the first user has accessed (e.g., episode 10), the media guidance application may exclude the other user from being presented in other users region 590. In response to determining that the episode number (e.g., episode 8) accessed by the other user does not exceed (or is less than) the episode number that the first user has accessed (e.g., episode 10), the media guidance application may include the other user in other users region 590.

In some embodiments, the media guidance application may determine when the other users have viewed the episode in the series relative to the first user to condition the presentation of the identification of the other users in region 590. In particular, the media guidance application may indicate other users, who have viewed a give media asset, in region 590 to the first user if those other users viewed the media asset within a threshold period of time of the first user. The media guidance application may retrieve from a viewing history a list of other users who viewed a given media asset that the first user has viewed. The media guidance application may also retrieve a date/time each of those other users viewed the given media asset. The media guidance application may compare the retrieved date/time with the date/time the first user has viewed the media asset. In response to determining that the date/time difference is lower than a threshold (e.g., less than 1 week), the media guidance application may indicate those other users to the first user in region 590.

In some embodiments, the media guidance application may present in other users region 590 any user who has accessed any episode in the series. In some embodiments, the media guidance application may present in other users region 590 any user who has accessed any episode in the series within a threshold period of time of the first user. In such circumstances, the media guidance application may visually distinguish those other users who have accessed episodes later in the series than the first user from those other users who have accessed episodes up to and including the episode accessed by the first user. For example, a user shown in region 590 who has accessed episode 11, which is later in the series than episode 10 that the first user has accessed, may be represented using an identifier that is in a first color. A user shown in region 590 who has accessed episode 9, which is earlier in the series than episode 10 that the first user has accessed, may be represented using an identifier that is in a second color.

In some embodiments, the media guidance application may limit the number other users who are non-friends with the first user that are presented in region 590 based on other factors. The other factors may include any combination of other common interests (e.g., common athlete or sporting event that the users share interest in), geographical location, geographical proximity to the first user, how recently the other users accessed or viewed the media asset relative to the first user, and/or whether the other users have friends in common with the first user.

In some embodiments, the media guidance application may present a contact friend option 552 for each of the other users shown in region 590 that are friends with the first user. In response to receiving a user selection of option 552, the media guidance application may enable the first user to compose a message for transmission to the corresponding friend. The message may be transmitted as a communication using communications circuitry of control circuitry 304 to the corresponding friend. The message may be posted to a social network page associated with the corresponding friend. The message may be transmitted as an SMS or MMS message or any other form of communication to the friend.

In some embodiments, the media guidance application may present a contact other user option 562 for each of the other users shown in region 590 that are non-friends of the first user. In response to receiving a user selection of option 562, the media guidance application may enable the first user to compose a message for transmission to the corresponding other user or request that the other user become friends with the first user on a social network. Particularly, the first user may invite the non-friend to become friends with the first user. If the non-friend accepts the request to become friends with the first user, the non-friend may be added to the list of friends associated with the first user stored on the social network server. The message may be transmitted as a communication using communications circuitry of control circuitry 304 to the corresponding non-friend. The message may be posted to a social network page associated with the corresponding non-friend. The message may be transmitted as an SMS or MMS message or any other form of communication to the non-friend.

In some embodiments, the media guidance application may synchronize viewing of the media asset in response to receiving a user selection of option 552 or 562. In particular, the media guidance application may enable the first user to synchronously view the media asset corresponding to identifier 520 with one or more other users in response to the first user selecting the content option associated with the one or more other users. For example, in response to receiving a user selection of option 552, the media guidance application may retrieve a calendar associated with the first user and the friend corresponding to option 552 (e.g., Tracy). The media guidance application may identify a time that is convenient to both the first user and Tracy and recommend that the two users access the media asset (e.g., the next episode in the series, such as “Battlestar Galactica,” episode 11) at the time identified to be convenient for the users. After the two users confirm their acceptance of the identified time, the media guidance application may automatically play the media asset for both users on a designated source (e.g., a designated channel or at a designated website address). This ensures that both users view the media asset synchronously.

In some embodiments, the media guidance application may present other users region 590 as an overlay on top of (or adjacent to, such as in a separate window or second screen device) an unpopular media asset that the user is accessing. The media guidance application may present other users region 590 at predetermined intervals, in the beginning, at the end, or any other automatically determined or user selected play position. All the functionality discussed in connection with other users region 590 in connection with screen 500 may be provided when other users region 590 is presented as an overlay on top of (or adjacent to, such as in a separate window or second screen device) the unpopular media asset.

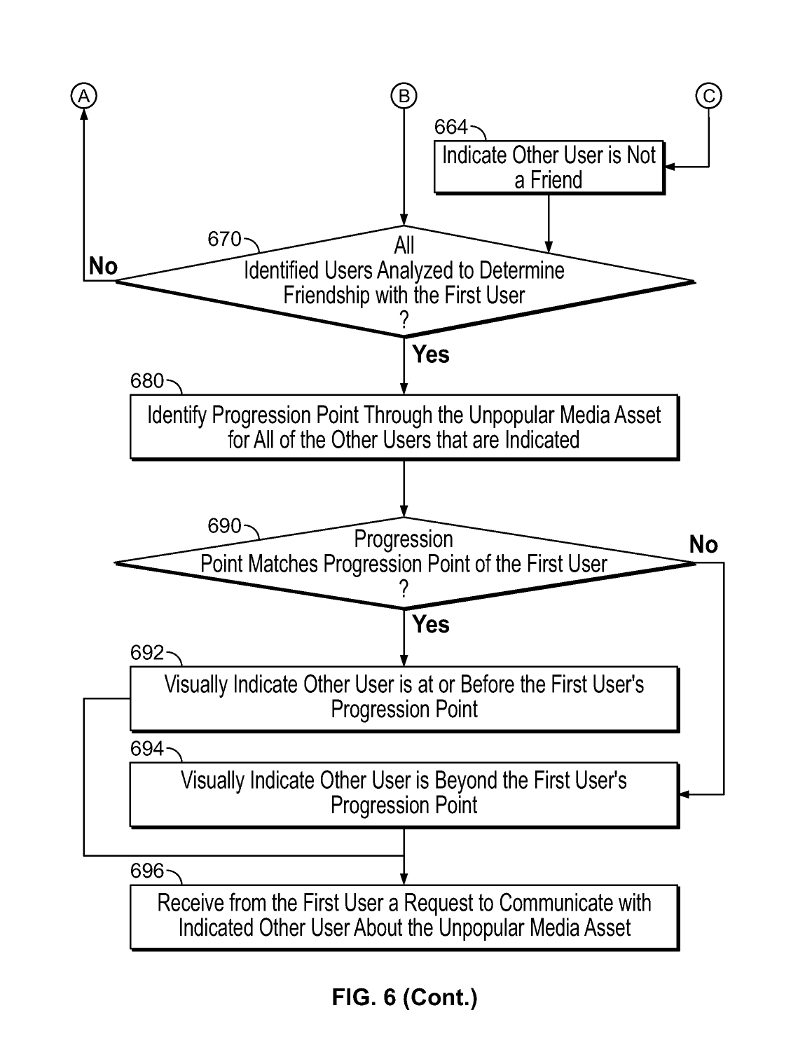

FIG. 6 shows an illustrative flow diagram of a process 600 for connecting users with a common interest in an unpopular media asset in accordance with an embodiment of the invention. At step 610, a request from a first user to access a media asset is received. For example, a first user using user equipment device 300 may request control circuitry 304 to change the content source (e.g., channel) or request that content be streamed from a given source. The request may be performed by the first user selecting a program listing from the grid shown in FIG. 1 or mosaic shown in FIG. 2.

At step 620, a determination is made as to whether the first user has viewed the media asset. In response to determining that the first user has viewed the media asset, the process proceeds to step 630, otherwise the process proceeds to step 620. For example, the media guidance application may retrieve a viewing history from storage 308 and determine whether the user has viewed the media asset. In some implementations, the media guidance application may determine whether the first user has viewed the media asset by comparing the progress point through the media asset to a threshold. If the progress point exceeds the threshold, the media guidance application may determine that the first user has viewed the media asset and may store an indication that the media asset has been viewed in the viewing history.

At step 630, popularity information associated with the media asset is retrieved. For example, the media guidance application may retrieve a data structure associated with the media asset from a local or remote database. The data structure may include popularity information for the media asset.

At step 640, a determination is made as to whether the popularity information associated with the media asset exceeds a popularity threshold. In response to determining that the popularity information exceeds the popularity threshold, the process proceeds to step 642, otherwise the process proceeds to step 610. For example, the media guidance application may compare the retrieved popularity information with a user-defined or predetermined threshold.

At step 642, a viewing history associated with the unpopular media asset is retrieved to identify other users who viewed the media asset. For example, the media guidance application may retrieve from storage 308 a viewing history associated with the media asset for which the popularity information does not exceed the threshold.

At step 650, a list of friends associated with the first user is identified on a social network. For example, the media guidance application may transmit a request to a social network server with an identifier of the first user. The request may instruct the social network server to identify other users that are associated with the first user on the social network. The social network server may return the list of friends to the media guidance application.

At step 660, a determination is made as to whether the identified other user is included in the list of friends. For example, the media guidance application may compare an identifier (e.g., name or username) of a user from the viewing history determined to have viewed the media asset with identifiers of friends of the first user.

At step 662, the identified other user is indicated to be a friend. For example, the media guidance application may present an identifier of the other user in a section of other users region 590 corresponding to friends of the first user (FIG. 5). In some implementations, the media guidance application may present the identifier of the other user who is a friend of the first user that has also viewed the media asset in a specific manner (e.g., in a given color or font).

At step 664, the identified other user is indicated not to be a friend. For example, the media guidance application may present an identifier of the other user in a section of other users region 590 corresponding to non-friends (FIG. 5). In some implementations, the media guidance application may present the identifier of the other user who is not a friend of the first user that has also viewed the media asset in a specific manner (e.g., in a given color or font). The manner in which the media guidance application presents identifiers of friends of the first user who also viewed the media asset may be different from the manner used to present identifiers of non-friends of the first user who also viewed the media asset.

At step 670, a determination is made as to whether all identified other users have been analyzed to determine friendship with the first user. In response to determining all identified other users have been analyzed, the process proceeds to step 660, otherwise the process proceeds to step 680.

At step 680, the progression point through the unpopular media asset is identified for all of the other users that are indicated. For example, the media guidance application may retrieve a viewing position or episode number for each user in the viewing history identified as having viewed the media asset that the first user has viewed.

At step 690, a determination is made as to whether the progression point matches the progression point of the first user. In response to determining the progression point matches, the process proceeds to step 692, otherwise the process proceeds to step 694.

At step 692, other users that are at or before the first user's progression point are visually indicated. For example, the media guidance application may present the identifiers of other users in region 590 in a specific manner (e.g., particular color or font) based on whether the other users that are listed are at or before the first user's progression point.

At step 694, other users that are beyond the first user's progression point are visually indicated. For example, the media guidance application may present the identifiers of other users in region 590 in a specific manner (e.g., particular color or font) based on whether the other users that are listed are beyond the first user's progression point. The identifiers of other users who are at a progression point that is beyond the first user's progression point may be visually distinguished from identifiers of other users who are at a progression point that is at or before the first user's progression point.

At step 696, a request is received from the first user to communicate with an indicated other about the unpopular media asset. For example, the media guidance application may receive a user selection of contact option 552 from the first user. In response, the media guidance application may enable the first user to compose a message to the corresponding other user and/or request to synchronize viewing of the media asset with the corresponding other user.

It should be understood that the above steps of the flow diagram of FIG. 6 may be executed or performed in any order or sequence not limited to the order and sequence shown and described in the figure. Also, some of the above steps of the flow diagram of FIG. 6 may be executed or performed substantially simultaneously where appropriate or in parallel to reduce latency and processing times.

The above-described embodiments of the present disclosure are presented for purposes of illustration and not of limitation, and the present disclosure is limited only by the claims which follow.

1. A method for connecting a plurality of users based on a common interest in an unpopular media asset, the method comprising:
receiving a request from a first user to access a media asset;
determining that the media asset is unpopular by determining that popularity of the media asset is below a threshold;
in response to determining that the media asset is unpopular, retrieving information, associated with the media asset, that identifies a plurality of other users that have requested access to the media asset;
selecting a second user from the plurality of other users; and
generating an indication for the first user that indicates the second user has a common interest in the media asset that is unpopular.

2. The method of claim 1, wherein selecting the second user comprises:
retrieving from a remote server a list of friends associated with the first user;
cross-referencing the plurality of other users with the list of friends to identify which of the other users is included in the list of friends; and
selecting as the second user one of the other users that is included in the list of friends.

3. The method of claim 1, wherein selecting the second user comprises:
retrieving from a remote server a list of friends associated with the first user;
cross-referencing the plurality of other users with the list of friends to identify which of the other users is not included in the list of friends; and
selecting as the second user one of the other users that is not included in the list of friends.

4. The method of claim 1, wherein determining that the media asset is unpopular comprises:
identifying a plurality of media assets that have been associated with a popularity that exceeds the threshold at a first point in time;
wherein the media asset is determined to be unpopular by determining which of the plurality of media assets is associated with a popularity that is below the threshold at a second point in time that is later than the first point in time.

5. The method of claim 4, wherein the first point in time precedes the second point in time by more than one year.

6. The method of claim 1, wherein the media asset corresponds to an episode in a series, further comprising:
determining a first episode number associated with the media asset to which the first user requested access;
determining which of the plurality of other users has requested access, within a threshold period of time from when the first user requested access to the media asset, to an episode of the series that is associated with a second episode number equal to or less than the first episode number; and
selecting as the second user one of the other users determined to have requested access to the media asset within the threshold period of time from when the first user requested access to the media asset.

7. The method of claim 1 further comprising transmitting a communication from the first user to the second user based on the indication.

8. The method of claim 1 further comprising adding the second user to a list of friends associated with the first user stored on a remote server.

9. The method of claim 1, wherein the indication is generated responsive to determining that the first user has accessed the media asset from start of the media asset to end of the media asset.

10. The method of claim 1, wherein the popularity of the media asset is determined based on at least one of posts to an online database, status updates of users on a remote server, or microblog entries, industry ratings metrics, and user-to-user recommendations.

11. A system for connecting a plurality of users based on a common interest in an unpopular media asset, the system comprising:
storage circuitry configured to store popularity of a media asset and a database of other users that have requested access to the media asset;
user input interface circuitry;
control circuitry configured to:
receive a request from the user input interface circuitry indicating a first user request for access to a media asset;
retrieve the popularity of the media asset and a threshold from the storage circuitry;
determine that the media asset is unpopular by determining that retrieved popularity of the media asset is below the threshold;
in response to determining that the media asset is unpopular, retrieve from the storage circuitry information, associated with the media asset, that identifies the plurality of other users that have requested access to the media asset;
select a second user from the plurality of other users; and
generate an indication for the first user that indicates the second user has a common interest in the media asset that is unpopular.

12. The system of claim 11, wherein the control circuitry is further configured to:
retrieve from a remote server a list of friends associated with the first user;
cross-reference the plurality of other users with the list of friends to identify which of the other users is included in the list of friends; and
select as the second user one of the other users that is included in the list of friends.

13. The system of claim 11, wherein the control circuitry is further configured to:
retrieve from a remote server a list of friends associated with the first user;
cross-reference the plurality of other users with the list of friends to identify which of the other users is not included in the list of friends; and
select as the second user one of the other users that is not included in the list of friends.

14. The system of claim 11, wherein the control circuitry is further configured to:
identify a plurality of media assets that have been associated with a popularity that exceeds the threshold at a first point in time; and
determine which of the plurality of media assets is associated with a popularity that is below the threshold at a second point in time that is later than the first point in time.

15. The system of claim 14, wherein the first point in time precedes the second point in time by more than one year.

16. The system of claim 11, wherein the media asset corresponds to an episode in a series, and wherein the control circuitry is further configured to:
determine a first episode number associated with the media asset to which the first user requested access;
determine which of the plurality of other users has requested access, within a threshold period of time from when the first user requested access to the media asset, to an episode of the series that is associated with a second episode number equal to or less than the first episode number; and
select as the second user one of the other users determined to have requested access to the media asset within the threshold period of time from when the first user requested access to the media asset.

17. The system of claim 11 further comprising communications circuitry, wherein the control circuitry is further configured to transmitting an instruction to the communications circuitry to transmit a communication from the first user to the second user based on the indication.

18. The system of claim 11, wherein the control circuitry is further configured to add the second user to a list of friends associated with the first user stored on a remote server.

19. The system of claim 11, wherein the indication is generated responsive to determining that the first user has accessed the media asset from start of the media asset to end of the media asset.

20. The system of claim 11, wherein the popularity of the media asset is determined based on at least one of posts to an online database, status updates of users on a remote server, or microblog entries, industry ratings metrics, and user-to-user recommendations.

21-50. (canceled)
